(19) United States
(12) Patent Application Publication
(10) Pub. No.: US 2024/0320731 A1
(43) Pub. Date: Sep. 26, 2024

(54) LOCATION-BASED SHOPPING LIST APPLICATION

(71) Applicant: Mark Ian Bethea, Herndon, VA (US)

(72) Inventor: Mark Ian Bethea, Herndon, VA (US)

(21) Appl. No.: 18/498,028

(22) Filed: Oct. 30, 2023

Related U.S. Application Data
(60) Provisional application No. 63/420,525, filed on Oct. 28, 2022.

(51) Int. Cl. G06Q 30/0601; H04W 4/02; H04W 4/021

(52) U.S. Cl. CPC G06Q 30/0639; G06Q 30/0633; H04W 4/021; H04W 4/023

(57) ABSTRACT

Computer-implemented shopping list methods, systems, and computer-readable media are described.

### FIELD

Some implementations are generally related to computerized organization systems and methods, and, in particular, to systems and methods for a location-based shopping list application.

### BACKGROUND

A need may exist for a shopping list application that accommodates impulse items, alerts users of the app that another user is at a store and helps remind users that items are needed based on the locations of the users.

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

### BRIEF DESCRIPTION OF THE DRAWINGS

FIG. 1 is a block diagram of an example system and a network environment which may be used for one or more implementations described herein.

FIG. 2 is a flowchart of an example shopping list process for user configuration and set-up in accordance with some implementations.

FIG. 3 is a flowchart of an example shopping list process for adding items to a shopping list in accordance with some implementations.

FIG. 4 is a flowchart of an example shopping list process with alerts about location in accordance with some implementations.

FIG. 5 is a flowchart of an example shopping list process for sale items in accordance with some implementations.

FIG. 6 is a block diagram of an example computing device which may be used for one or more implementations described herein.

### DETAILED DESCRIPTION

Some implementations include shopping list methods and systems. The systems and methods provided herein may overcome one or more deficiencies of some conventional shopping list systems and methods. For example, there are a number of applications that help consumers create and manage shopping lists for things like groceries and other common household items.

The various conventional apps can include methods for sorting, categorizing, and keeping track of staples like eggs, milk and spices. These apps function for people who use “shopping lists” when they shop. Unfortunately, most consumers have no solution for “impulse” shopping trips, the way a percentage of the public actually shops. And more importantly, conventional apps may not help remind people that there is shopping that needs to be done.

Some implementations can provide a solution that can use GPS location data (or another location technology) to alert users when they are near a store to remind them to stop and go shopping. Also, in some implementations, whenever a user is within a custom set radius or distance of an appropriate store, the application will alert the user with either a ringtone, vibration or SMS message, reminding them to stop and the application can display the current shopping list.

In some implementations, the application provides multi-platform compatibility (e.g., IOS, ANDROID, MAC OS and PC). Some implementations can provide voice control of functions. Some implementations can include SMS alert options. Some implementations provide user selectable mapping integration (e.g., via Google Maps, MapQuest, Apple Maps or Yahoo Maps, or the like).

Some implementations permit a user to configure default, favorite and custom store preferences. Further, some implementations provide for sharing of shopping lists (and locations or other related shopping information) with a limited number of “Family Members” or “Group Users” in a first version or a larger number of Users in a second version.

In some implementations, shopping lists and alerts can be shared with any and/or all users. Some implementations can provide real-time list updates that propagate to all designated users to help prevent duplicate purchases of items. Some implementations can include creation of “priority” shopping items and sending of alerts to all members of a group for shopping list items that are needed immediately or urgently.

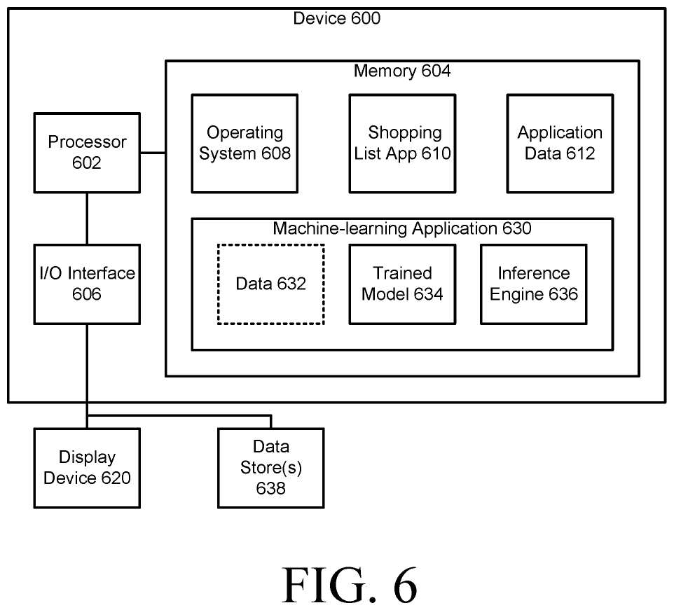

When performing computerized shopping list functions, it may be helpful for a system to suggest items to add to a shopping list, locations to add, and/or to make predictions about items that may be needed. To make predictions or suggestions, a probabilistic model (or other model as described below in conjunction with FIG. 6) can be used to make an inference (or prediction) about aspects of a shopping list such as items, locations, or users to alert. Accordingly, it may be helpful to make an inference regarding a probability that an item should be added to a shopping list. Other aspects can be predicted or suggested as described below.

Yet another advantage is that the methods and systems described herein can dynamically learn new thresholds (e.g., for confidence scores, etc.) and provide suggestions for shopping list items that match the new thresholds. The systems and methods presented herein automatically provide shopping list suggestions that are more likely to be accepted by users and that likely are more accurate.

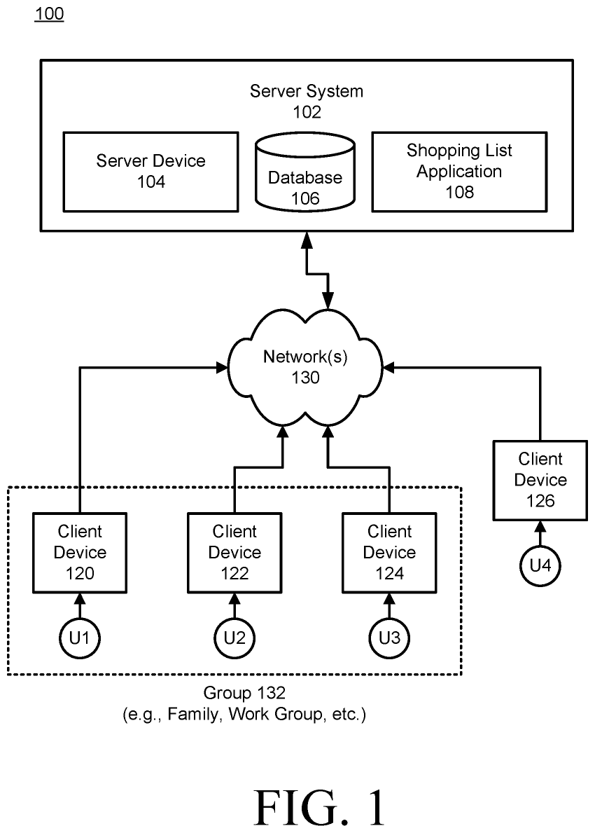

FIG. 1 illustrates a block diagram of an example network environment 100, which may be used in some implementations described herein. In some implementations, network environment 100 includes one or more server systems, e.g., server system 102 in the example of FIG. 1A. Server system 102 can communicate with a network 130, for example. Server system 102 can include a server device 104, a database 106 or other data store or data storage device, and a shopping list application 108. Network environment 100 also can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, switch or hub connections, etc.

For ease of illustration, FIG. 1 shows one block for server system 102, server device 104, and database 106, and shows four blocks for client devices 120, 122, 124, and 126. Some blocks (e.g., 102, 104, and 106) may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client device can be any type of electronic device, e.g., desktop computer, laptop computer, portable or mobile device, camera, cell phone, smart phone, tablet computer, television, TV set top box or entertainment device, wearable devices (e.g., display glasses or goggles, head-mounted display (HMD), wristwatch, headset, armband, jewelry, etc.), virtual reality (VR) and/or augmented reality (AR) enabled devices, personal digital assistant (PDA), media player, game device, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective client devices 120, 122, 124, and 126. In some examples, users U1, U2, U3, and U4 may interact with each other via applications running on respective client devices and/or server system 102, and/or via a network service, e.g., an image sharing service, a messaging service, a social network service or other type of network service, implemented on server system 102. For example, respective client devices 120, 122, 124, and 126 may communicate data to and from one or more server systems (e.g., server system 102). In some implementations, the server system 102 may provide appropriate data to the client devices such that each client device can receive communicated content or shared content uploaded to the server system 102 and/or network service. In some examples, the users can interact via audio or video conferencing, audio, video, text chat, or other communication modes or applications. In some examples, the network service can include any system allowing users to perform a variety of communications, form links and associations, upload and post shared content such as images, image compositions (e.g., albums that include one or more images, image collages, videos, etc.), audio data, and other types of content, receive various forms of data, and/or perform socially related functions. For example, the network service can allow a user to send messages to particular or multiple other users, form social links in the form of associations to other users within the network service, group other users in user lists, friends lists, or other user groups, post or send content including text, images, image compositions, audio sequences or recordings, or other types of content for access by designated sets of users of the network service, participate in live video, audio, and/or text videoconferences or chat with other users of the service, etc. In some implementations, a “user” can include one or more programs or virtual entities, as well as persons that interface with the system or network.

A user interface can enable display of images, image compositions, data, and other content as well as communications, privacy settings, notifications, and other data on client devices 120, 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, e.g., a display screen, projector, etc. In some implementations, application programs running on a server system can communicate with a client device to receive user input at the client device and to output data such as visual data, audio data, etc. at the client device.

In some implementations, server system 102 and/or one or more client devices 120-126 can provide shopping list functions as described herein. Also, two or more users can be in a group (e.g., group 132).

Various implementations of features described herein can use any type of system and/or service. Any type of electronic device can make use of the features described herein. Some implementations can provide one or more features described herein on client or server devices disconnected from or intermittently connected to computer networks.

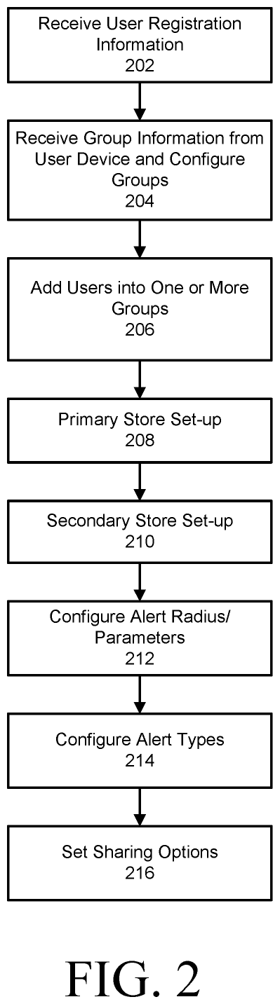

FIG. 2 is a flowchart of an example shopping list process for user configuration and set-up in accordance with some implementations. Processing begins at 202, where user registration information is received. User registration information can include one or more names, password, email address, mobile number, home address, work address, or the like. Processing continues to 204.

At 204, names for one or more groups are set up (e.g., family, work, etc.). For example, the group processes may (or may not) be present in all versions of the app. Different options can exist for the group options depending on which version/iteration of the app a user chooses. For example, in the lowest paid version of the app, the group feature can permit up to four users in one group. There can also be single user options and in these versions, there will be no group functions. For the basic setup for a single user, processing may skip to 208. Group Setup Process: The GROUP processes may (or may not) be present in all versions of the App. Different options will exist for the GROUP options depending on which version/iteration of the App the clients choose. For example, in the lowest PAID version of the App, we might include up to four users in one GROUP. There will also be SINGLE USER options and in these versions, there will be NO GROUP functions.

In some implementations, in the group setup routine, each user can set up “PRIVATE” or “PERSONAL” items on the Shopping List that will not be shown to other group users but that will only appear to that user. Examples are feminine hygiene products, medical items and items that only that user will consume (e.g., special snacks, technical gadgets, alcoholic beverages, and other items that the other group users would not—or should not—usually buy for the user). Processing continues to 206.

At 206, one or more users are added to one or more respective groups. Adding users can include adding information for each user such as nickname, mobile phone number, email, etc. Processing continues 208.

At 208, a primary or default store is configured including the store name (or nickname) and store category (e.g., grocery, drug store, etc.). The primary store can be a store where a user does most of their shopping (e.g., close to home or work). Optionally, if the primary store is part of a major retail chain with loyalty or membership options. The specific chain can be selected or added, and alerts can include proximity to other locations of the chain. Processing continues to 210.

At 210, a secondary store is set up similar to the set-up of the primary store described above. The secondary store can include a store that is next closest to the user's home or work, etc. For example, in some implementations secondary store setup can include different options for store categories (e.g., as noted, these might include grocery, drug store, liquor store) but there will also be a need for “Big Box” stores like Costco, Sam's Club, and maybe Walmart etc. So, prior to setting the secondary store, the user should be prompted to select/designate store categories that will be used. Each store category could then have a default and secondary store for that specific category. And to reiterate, not all versions of the App might include the ability to designate multiple “Categories” of stores. Processing continues to 212.

At 212, the distance (or radius) from the primary and secondary stores (or other stores) that will trigger standard alerts is received. The radius for priority alerts can also be received. Processing continues to 214.

At 214, option configuration for ringtone, vibration, and/or SMS messages for alerts. Processing continues to 216.

At 216, settings for sharing options are received and configured. For example, sharing settings can include sharing all items all the time, sharing only priority items, or not sharing any items. One purpose of setting up groups can be to activate the ability to share lists and items. When adding an item to the list, it can be shared with the group to which the list is assigned. For example, if USER A adds “milk” to the “Household Grocery” list, it would automatically be shared with the GROUP “Household” without further action being taken. If that same USER A adds “Flamin' Hot Doritos” to their “PRIVATE” list, it would, by default, NOT be shared with the GROUP “Household”.

In some implementations, the “PRIORITY” designation exists at the ITEM level and not the GROUP level. For example, if a female user has an immediate need for a feminine product (one that would NOT normally appear on the Group list), she can designate that as a PRIORITY item, and it would be marked as such at the ITEM level. So, the PRIORITY designation can be activated at the ITEM level regardless of that item's status as a Group or Personal classification.

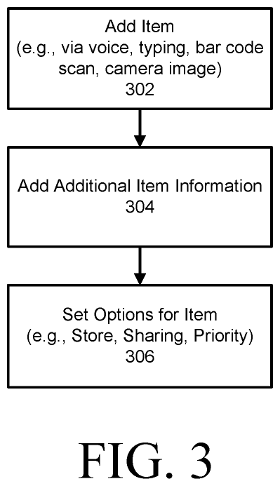

FIG. 3 is a flowchart of an example shopping list process for adding items to a shopping list in accordance with some implementations. Processing begins at 302, where an item is added to a shopping list. The item information can be received through a variety of interfaces including voice input, typing, bar code scanning, image capture, etc. Once the item has been added additional details and options can be added. Processing continues to 304.

At 304, additional information about the item can be received and added to the shopping list data. For example, the additional information can include one or more of quantity, size, color, or other information. Processing continues to 306.

At 306, options can be added for the item. The options can include a designated store for the item. If no store is specified, then the primary and/or secondary stores are used. Sharing information can be added, which can include which user or groups to share the item with. Typically, sharing options would be set at the group level.

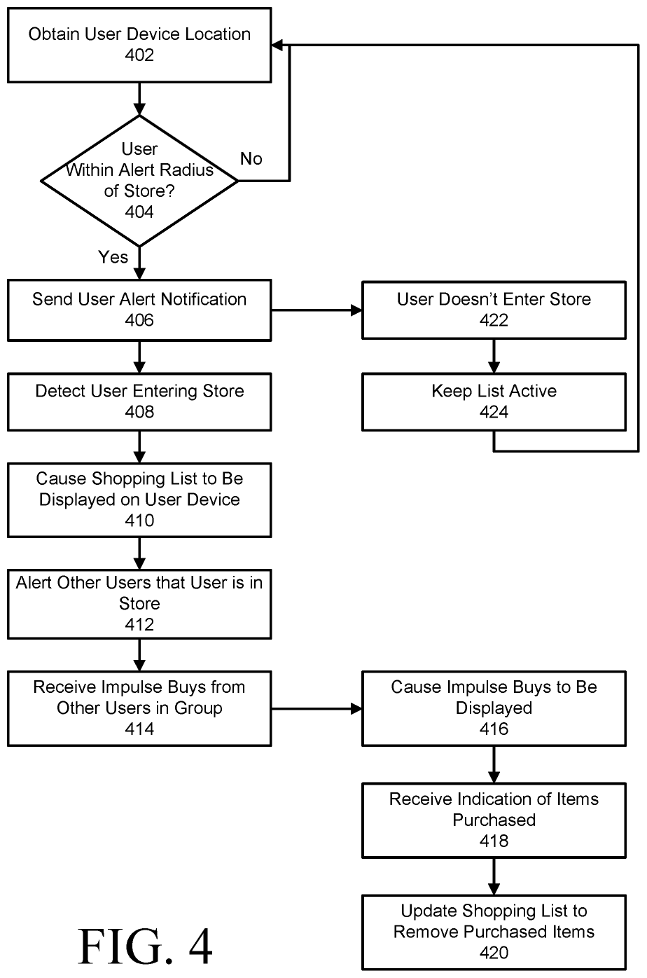

FIG. 4 is a flowchart of an example shopping list process with alerts about location in accordance with some implementations. Processing begins at 402, where the location of a user device is obtained. For example, the location can be obtained by GPS, wi-fi, or other location technology. Alternatively, a user can enter a location. Processing continues to 404.

At 404, it is determined whether the user is within an alert radius of a store associated with one or more items on the shopping list. If so, processing continues to 406. Otherwise, processing continues back to 402.

At 406, an alert notification is sent to the user within the alert radius. If the user enters the store (as determined by user entry to the app or user device location determination), processing continues to 408. In some implementations, a prompt can be displayed=(or an audio prompt provided) informing the user that they are within the radius of a store (and maybe describe the store—e.g., name or category) and asking the user if they want to stop at the store. If the User wants to stop, the user can respond e.g., via voice prompt (answer) or by tapping an option on the screen. After the selection to stop has been made, the app can display the appropriate shopping list. In another implementation, if the User is currently using a mapping application (e.g., Google Maps) for navigation, the system would insert the store address and update the destination in the navigation system. After the destination has been updated (see above note), the shopping list should automatically pop up in the App (according to the store name or category). If the user doesn't want to stop or doesn't enter the store, processing continues to 422.

At 408, the system detects the user entering the store (e.g., via GPS, Wi-Fi, Bluetooth, etc.) or via a user providing an indication to the app that the user is entering the store. Processing continues to 410.

At 410, the shopping list is displayed on the user device. In some implementations, the App could find the location of all items on the shopping list according to available store maps and then determine an optimized “Shopping Flow” that would logically take the user from one end of the store to the other in the most efficient manner to collect all items on the shopping list. Processing continues to 412.

At 412, the system alerts others in the group that the user is in the store. Processing continues to 414.

At 414, one or more impulse buys, if any, are received from others in the group. Processing continues to 416.

At 416, the impulse buys are displayed on the user device of the user in the store. Processing continues 418.

At 418, receive an indication of items purchased. The indication of items purchased can be received via a user tapping a checkmark next to the item on the list, by a user scanning the barcode of the item with their phone, via voice prompts, or other suitable method. The barcode scanning can be done via the camera of a user's phone or via a UPC reader interface and accessing the UPC Code Database to identify the specific item. Processing continues to 420.

At 420, update shopping list to remove purchased items. In some implementations, the shopping list can be updated in real time as items are checked off the list. This can include updating the list for all group users, also in real time. This functionality would be variable based on how a given user shops (e.g., do they check items off the list as they put them in the cart, or do they wait until they are in the checkout line to check the items off the list?).

At 422, when the user doesn't enter the store, the list is kept active 424.

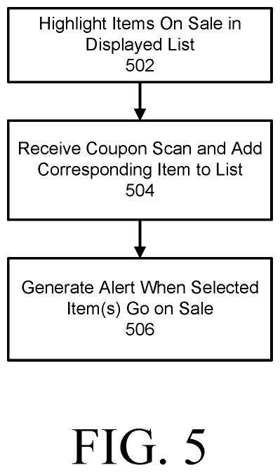

FIG. 5 is a flowchart of an example shopping list process for sale items in accordance with some implementations. Processing begins at 502, where items on the shopping list that are on sale are optionally highlighted in the displayed list. The sale information can be obtained from an external system such as a store system. In some implementations, shopping list items at Primary and/or Secondary stores may be compared with the same (or similar) items that the store has on “Sale” and any such items will be highlighted in the displayed list. This feature may be activated in the Shopping List Setup routine as an option to “Search for similar items on Sale.” Processing continues to 504.

At 504, a user can optionally add an item to the shopping list by scanning a coupon. Processing continues to 506.

At 506, an alert notification can optionally be generated and sent to users when an item goes on sale.

FIG. 6 is a block diagram of an example device 600 which may be used to implement one or more features described herein. In one example, device 600 may be used to implement a client device, e.g., any of client devices 120-126 shown in FIG. 1. Alternatively, device 600 can implement a server device, e.g., server device 104, etc. In some implementations, device 600 may be used to implement a client device, a server device, or a combination of the above. Device 600 can be any suitable computer system, server, or other electronic or hardware device as described above.

One or more methods described herein (e.g., computerized shopping list applications) can be run in a standalone program that can be executed on any type of computing device, a program run on a web browser, a mobile application (“app”) run on a mobile computing device (e.g., cell phone, smart phone, tablet computer, wearable device (wristwatch, armband, jewelry, headwear, virtual reality goggles or glasses, augmented reality goggles or glasses, head mounted display, etc.), laptop computer, etc.).

In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

In some implementations, device 600 includes a processor 602, a memory 604, and I/O interface 606. Processor 602 can be one or more processors and/or processing circuits to execute program code and control basic operations of the device 600. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems.

In some implementations, processor 602 may include one or more co-processors that implement neural-network processing. In some implementations, processor 602 may be a processor that processes data to produce probabilistic output, e.g., the output produced by processor 602 may be imprecise or may be accurate within a range from an expected output. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 604 is typically provided in device 600 for access by the processor 602 and may be any suitable processor-readable storage medium, such as random-access memory (RAM), read-only memory (ROM), Electrically Erasable Read-only Memory (EEPROM), Flash memory, etc., suitable for storing instructions for execution by the processor, and located separate from processor 602 and/or integrated therewith. Memory 604 can store software operating on the server device 600 by the processor 602, including an operating system 408, machine-learning application 630, shopping list application 610, and application data 612. Other applications may include applications such as a data display engine, web hosting engine, image display engine, notification engine, social networking engine, etc. In some implementations, the machine-learning application 630 and shopping list application 610 can each include instructions that enable processor 602 to perform functions described herein, e.g., some or all of the methods of FIGS. 2-5.

The machine-learning application 630 can include one or more NER implementations for which supervised and/or unsupervised learning can be used. The machine learning models can include multi-task learning based models, residual task bidirectional LSTM (long short-term memory) with conditional random fields, statistical NER, etc. The Device can also include a shopping list application 610 as described herein and other applications. One or more methods disclosed herein can operate in several environments and platforms, e.g., as a stand-alone computer program that can run on any type of computing device, as a web application having web pages, as a mobile application (“app”) run on a mobile computing device, etc.

In various implementations, machine-learning application 630 may utilize Bayesian classifiers, support vector machines, neural networks, or other learning techniques. In some implementations, machine-learning application 630 may include a trained model 634, an inference engine 636, and data 632. In some implementations, data 432 may include training data, e.g., data used to generate trained model 634. For example, training data may include any type of data suitable for training a model for shopping list application tasks, such as images, labels, thresholds, etc. associated with shopping list application described herein. Training data may be obtained from any source, e.g., a data repository specifically marked for training, data for which permission is provided for use as training data for machine-learning, etc. In implementations where one or more users permit use of their respective user data to train a machine-learning model, e.g., trained model 634, training data may include such user data. In implementations where users permit use of their respective user data, data 632 may include permitted data.

In some implementations, data 632 may include collected data such as shopping list items, locations, impulse purchases, alerts, locations, etc. In some implementations, training data may include synthetic data generated for the purpose of training, such as data that is not based on user input or activity in the context that is being trained, e.g., data generated from simulated conversations, computer-generated images, etc. In some implementations, machine-learning application 630 excludes data 632. For example, in these implementations, the trained model 634 may be generated, e.g., on a different device, and be provided as part of machine-learning application 630. In various implementations, the trained model 634 may be provided as a data file that includes a model structure or form, and associated weights. Inference engine 636 may read the data file for trained model 634 and implement a neural network with node connectivity, layers, and weights based on the model structure or form specified in trained model 634.

Machine-learning application 630 also includes a trained model 634. In some implementations, the trained model 634 may include one or more model forms or structures. For example, model forms or structures can include any type of neural-network, such as a linear network, a deep neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that takes as input sequential data, such as words in a sentence, frames in a video, etc. and produces as output a result sequence), etc.

The model form or structure may specify connectivity between various nodes and organization of nodes into layers. For example, nodes of a first layer (e.g., input layer) may receive data as input data 632 or application data 612. Such data can include, for example, images, e.g., when the trained model is used for shopping list application functions. Subsequent intermediate layers may receive as input output of nodes of a previous layer per the connectivity specified in the model form or structure. These layers may also be referred to as hidden layers. A final layer (e.g., output layer) produces an output of the machine-learning application. For example, the output may be a set of items to suggest to user depending on the specific trained model. In some implementations, model form or structure also specifies a number and/or type of nodes in each layer.

In different implementations, the trained model 634 can include a plurality of nodes, arranged into layers per the model structure or form. In some implementations, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output.

In some implementations, the computation performed by a node may also include applying a step/activation function to the adjusted weighted sum. In some implementations, the step/activation function may be a nonlinear function. In various implementations, such computation may include operations such as matrix multiplication. In some implementations, computations by the plurality of nodes may be performed in parallel, e.g., using multiple processors cores of a multicore processor, using individual processing units of a GPU, or special-purpose neural circuitry. In some implementations, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM). Models with such nodes may be useful in processing sequential data, e.g., words in a sentence or a paragraph, frames in a video, speech or other audio, etc.

In some implementations, trained model 634 may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using data 632, to produce a result.

For example, training may include applying supervised learning techniques. In supervised learning, the training data can include a plurality of inputs (e.g., a set of images) and a corresponding expected output for each input. Based on a comparison of the output of the model with the expected output, values of the weights are automatically adjusted, e.g., in a manner that increases a probability that the model produces the expected output when provided similar input.

In some implementations, training may include applying unsupervised learning techniques. In unsupervised learning, only input data may be provided, and the model may be trained to differentiate data, e.g., to cluster input data into a plurality of groups, where each group includes input data that are similar in some manner.

In another example, a model trained using unsupervised learning may cluster words based on the use of the words in data sources. In some implementations, unsupervised learning may be used to produce knowledge representations, e.g., that may be used by machine-learning application 630. In various implementations, a trained model includes a set of weights, or embeddings, corresponding to the model structure. In implementations where data 632 is omitted, machine-learning application 630 may include trained model 634 that is based on prior training, e.g., by a developer of the machine-learning application 630, by a third-party, etc. In some implementations, trained model 634 may include a set of weights that are fixed, e.g., downloaded from a server that provides the weights.

Machine-learning application 630 also includes an inference engine 636. Inference engine 636 is configured to apply the trained model 634 to data, such as application data 612, to provide an inference. In some implementations, inference engine 636 may include software code to be executed by processor 602. In some implementations, inference engine 636 may specify circuit configuration (e.g., for a programmable processor, for a field programmable gate array (FPGA), etc.) enabling processor 602 to apply the trained model. In some implementations, inference engine 636 may include software instructions, hardware instructions, or a combination. In some implementations, inference engine 636 may offer an application programming interface (API) that can be used by operating system 608 and/or shopping list application 610 to invoke inference engine 636, e.g., to apply trained model 634 to application data 612 to generate an inference.

Machine-learning application 630 may provide several technical advantages. For example, when trained model 634 is generated based on unsupervised learning, trained model 634 can be applied by inference engine 636 to produce knowledge representations (e.g., numeric representations) from input data, e.g., application data 612. For example, a model trained for shopping list tasks may produce predictions and confidences for given input information about a shopping list being proposed or planned. A model trained for suggesting shopping list items may produce a suggestion for one or more items. In some implementations, such representations may be helpful to reduce processing cost (e.g., computational cost, memory usage, etc.) to generate an output (e.g., a suggestion, a prediction, a classification, etc.). In some implementations, such representations may be provided as input to a different machine-learning application that produces output from the output of inference engine 636.

In some implementations, knowledge representations generated by machine-learning application 630 may be provided to a different device that conducts further processing, e.g., over a network. In such implementations, providing the knowledge representations rather than the images may provide a technical benefit, e.g., enable faster data transmission with reduced cost. In another example, a model trained for shopping list functions may produce a signal for one or more lists being processed by the model.

In some implementations, machine-learning application 630 may be implemented in an offline manner. In these implementations, trained model 634 may be generated in a first stage and provided as part of machine-learning application 630. In some implementations, machine-learning application 630 may be implemented in an online manner. For example, in such implementations, an application that invokes machine-learning application 630 (e.g., operating system 608, one or more of shopping list application 610 or other applications) may utilize an inference produced by machine-learning application 630, e.g., provide the inference to a user, and may generate system logs (e.g., if permitted by the user, an action taken by the user based on the inference; or if utilized as input for further processing, a result of the further processing). System logs may be produced periodically, e.g., hourly, monthly, quarterly, etc. and may be used, with user permission, to update trained model 634, e.g., to update embeddings for trained model 634.

In some implementations, machine-learning application 630 may be implemented in a manner that can adapt to particular configuration of device 600 on which the machine-learning application 630 is executed. For example, machine-learning application 630 may determine a computational graph that utilizes available computational resources, e.g., processor 602. For example, if machine-learning application 630 is implemented as a distributed application on multiple devices, machine-learning application 630 may determine computations to be carried out on individual devices in a manner that optimizes computation. In another example, machine-learning application 630 may determine that processor 602 includes a GPU with a particular number of GPU cores (e.g., 1000) and implement the inference engine accordingly (e.g., as 1000 individual processes or threads).

In some implementations, machine-learning application 630 may implement an ensemble of trained models. For example, trained model 634 may include a plurality of trained models that are each applicable to the same input data. In these implementations, machine-learning application 630 may choose a particular trained model, e.g., based on available computational resources, success rate with prior inferences, etc. In some implementations, machine-learning application 630 may execute inference engine 636 such that a plurality of trained models is applied. In these implementations, machine-learning application 630 may combine outputs from applying individual models, e.g., using a voting-technique that scores individual outputs from applying each trained model, or by choosing one or more particular outputs. Further, in these implementations, machine-learning applications may apply a time threshold for applying individual trained models (e.g., 0.5 ms) and utilize only those individual outputs that are available within the time threshold. Outputs that are not received within the time threshold may not be utilized, e.g., discarded. For example, such approaches may be suitable when there is a time limit specified while invoking the machine-learning application, e.g., by operating system 608 or one or more other applications, e.g., shopping list application 610.

In different implementations, machine-learning application 630 can produce different types of outputs. For example, machine-learning application 630 can provide representations or clusters (e.g., numeric representations of input data), labels (e.g., for input data that includes images, documents, etc.), phrases or sentences (e.g., descriptive of an image or video, suitable for use as a response to an input sentence, suitable for use to determine context during a conversation, etc.), images (e.g., generated by the machine-learning application in response to input), audio or video (e.g., in response an input video, machine-learning application 630 may produce an output video with a particular effect applied, e.g., rendered in a comic-book or particular artist's style, when trained model 634 is trained using training data from the comic book or particular artist, etc. In some implementations, machine-learning application 630 may produce an output based on a format specified by an invoking application, e.g., operating system 608 or one or more applications, e.g., shopping list application 610. In some implementations, an invoking application may be another machine-learning application. For example, such configurations may be used in generative adversarial networks, where an invoking machine-learning application is trained using output from machine-learning application 630 and vice-versa.

Any of the software in memory 604 can alternatively be stored on any other suitable storage location or computer-readable medium. In addition, memory 604 (and/or other connected storage device(s)) can store one or more messages, one or more taxonomies, electronic encyclopedia, dictionaries, thesauruses, knowledge bases, message data, grammars, user preferences, and/or other instructions and data used in the features described herein. Memory 604 and any other type of storage (magnetic disk, optical disk, magnetic tape, or other tangible media) can be considered “storage” or “storage devices.”

I/O interface 606 can provide functions to enable interfacing the server device 600 with other systems and devices. Interfaced devices can be included as part of the device 600 or can be separate and communicate with the device 600. For example, network communication devices, storage devices (e.g., memory and/or database 106), and input/output devices can communicate via I/O interface 606. In some implementations, the I/O interface can connect to interface devices such as input devices (keyboard, pointing device, touchscreen, microphone, camera, scanner, sensors, etc.) and/or output devices (display devices, speaker devices, printers, motors, etc.).

Some examples of interfaced devices that can connect to I/O interface 606 can include one or more display devices 620 and one or more data stores 638 (as discussed above). The display devices 620 that can be used to display content, e.g., a user interface of an output application as described herein. Display device 620 can be connected to device 600 via local connections (e.g., display bus) and/or via networked connections and can be any suitable display device. Display device 620 can include any suitable display device such as an LCD, LED, or plasma display screen, CRT, television, monitor, touchscreen, 3-D display screen, or other visual display device. For example, display device 620 can be a flat display screen provided on a mobile device, multiple display screens provided in a goggles or headset device, or a monitor screen for a computer device.

The I/O interface 606 can interface to other input and output devices. Some examples include one or more cameras which can capture images. Some implementations can provide a microphone for capturing sound (e.g., as a part of captured images, voice commands, etc.), audio speaker devices for outputting sound, or other input and output devices.

For ease of illustration, FIG. 6 shows one block for each of processor 602, memory 604, I/O interface 606, and software blocks 608, 610, and 630. These blocks may represent one or more processors or processing circuitries, operating systems, memories, I/O interfaces, applications, and/or software modules. In other implementations, device 600 may not have all of the components shown and/or may have other elements including other types of elements instead of, or in addition to, those shown herein. While some components are described as performing blocks and operations as described in some implementations herein, any suitable component or combination of components of environment 100, device 600, similar systems, or any suitable processor or processors associated with such a system, may perform the blocks and operations described.

In some implementations, the shopping list system could include a machine-learning model (as described herein) for tuning the system (e.g., selecting functional image labels and corresponding thresholds) to potentially provide improved accuracy. Example machine-learning model input can include labels for a simple implementation and can be augmented with descriptor vector features for a more advanced implementation. Output of the machine-learning module can include a prediction of items that a user may wish to add to a shopping list.

One or more methods described herein (e.g., methods in FIGS. 2-5) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed, e.g., procedural or object-oriented. The routines may be executed on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer implemented method comprising:
receiving user registration information, wherein the user registration information includes one or more of name, password, email address, mobile number, home address, and work address;
receiving a name for one or more groups;
adding one or more users to the one or more respective groups;
configuring a primary store;
configuring a secondary store;
receiving a distance from the primary store and the secondary store that will trigger a standard alert;
receiving settings for sharing options;
adding an item to a shopping list;
receiving additional information about the item and adding the additional information to the shopping list data;
obtaining a location of a user device is obtained;
determining whether the user device is within an alert radius of a store associated with one or more items on the shopping list;
based on the determining, when the user device is within the alert radius, sending an alert notification to the user device within the alert radius;
detecting the user device entering the store;
displaying the shopping list on the user device;
alerting others in the group that a user associated with the user device is in the store;
receiving an indication of items purchased;
updating the shopping list to remove purchased items; and
when the user doesn't enter the store, keeping the list active.
